(19) United States
(12) Patent Application Publication
(10) Pub. No.: US 2012/0117463 A1
(43) Pub. Date: May 10, 2012

(54) LARGE SCALE DOCUMENT GENERATION

(76) Inventor: Andrew Inglis, Brighton, MA (US)

(21) Appl. No.: 13/292,009

(22) Filed: Nov. 8, 2011

Related U.S. Application Data
(60) Provisional application No. 61/456,631, filed on Nov. 9, 2010.

(51) Int. Cl. G06F 17/00

(52) U.S. Cl. 715/255

(57) ABSTRACT

Methods and apparatus, including computer program products, for large scale document generation. A method includes receiving edits made on a document by one or more contributors, receiving votes taken by the one or more contributors to decide which edits will create a new version of the document, reducing an overall edits made by the one or more contributors as packages, collecting the one or more contributors' personal characteristics and positive or negative attitudes towards the document details and displays each contributor's personal characteristics and positive or negative attitudes towards the document details so that it is known by all of the contributors how voted-in edits will change a support level of all contributors, merging voted-on packages into a new version of the document so that non-conflicting packages are included into the new version of the document according to a process that maximizes the intent of the voting, and storing the document in multiple languages at the same time by automatically and/or manually translating edits that are made in given languages to all the other supported languages.

### CROSS-REFERENCE TO RELATED APPLICATIONS

This application claims the benefit of U.S. Provisional Application No. 61/456,631, filed Nov. 9, 2010, and titled LARGE SCALE DOCUMENT GENERATION, which is incorporated by reference in its entirety.

### BACKGROUND OF THE INVENTION

The invention generally relates computer systems and computer executed methods of large scale document generation.

In general, one person can create a document that expresses her ideas, thoughts, and proposed actions to the world. The tools that enable a person to do this are numerous and include, for example, a piece of paper, a typewriter, a word processing editor such as OpenOffice Writer, an Internet publishing tool such as a blog, an email account, and so forth. The same is the case for a small group of people of less than four or five. In this case, it is also straightforward for a group of people to use the same types of systems that the individual person uses (e.g., OpenOffice Writer) to create a document that mutually maximizes their satisfaction. This is because it is possible for the group to talk during the editing process, and settle to a consensus about what to write. For a larger group of five to twenty people, the collaboration process gets more challenging. It is challenging to get everyone together at the same time, and when that is possible, it is difficult to come to a consensus with such a large group. This situation gets increasingly difficult as even more people (e.g., one hundred, one thousand, or ten thousand or more) want to contribute to a single document. Previously developed document sharing methods have the potential to streamline the collaboration process as the number of authors increase in number, especially when authors are in different locations and direct communication is not possible. However, previously developed methods have limitations on how many people can cohesively participate in a single document sharing and creation endeavor. This is because previously developed methods have focused on enabling like-minded people to create documents together. Also, previously developed methods are designed to work with a limited amount of content generation (e.g., edits) per unit time which limits daily creation activities to tens of thousands of people or less, and in most cases to thousands or hundreds of people or less. One example of such a method is a Wiki, popularized by the Wikipedia Project. Although the system allows for an unlimited number of people to contribute, it cannot handle the volume of communication generated by thousands of editors focusing on a single document at a given time, nor can it handle ideas to be drafted that are controversial in nature by non like-minded people. Furthermore, previously designed methods focus on the traditional method of document collaboration, where there is a leader or head author of the document, and there is a number of like-minded people contributing changes to the document. These limitations have not previously been seen as limitations as it has it has only been organizations of like-minded people within hierarchical decision making structures performing collaborative document creation, or as collaborative document creation has occurred to create encyclopedias (as with Wikipedia), where there is usually less than thousands of experts contributing to any given document attempting to create the document together, and consensus is driven by an overarching rule to keep the document factual and historical in nature. These limitations have also not been seen because when the need does arise for a much larger group of people to support a document, the standard model of document generation is for there to be a set of representatives from the larger group—either voted in by the larger group in cases of governance, or self appointed in terms of activists creating a petition—to use previously developed document creation tools to create the document. With previously designed methods therefore it is not possible to allow very large groups of people of greater than thousands to seven billion people to edit, contribute, and feel a sense of ownership in a single document, where the content of the document is not historical or factual in nature, and where there is no controlling head author or authors making the final decision on the document.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for large scale document generation.

In general, in one aspect, the invention's features includes receiving edits made on a document by one or more contributors, receiving votes taken by the one or more contributors to decide which edits will create a new version of the document, reducing an overall edits made by the one or more contributors as a sub-edits which are voted on, collecting the one or more contributors' personal characteristics and positive or negative attitudes towards the document details and displays each contributor's personal characteristics and positive or negative attitudes towards the document details so that it is known by all of the contributors how voted-in edits will change a support level of the entire group of contributors, merging voted-on sub-edits into a new version of the document so that non-conflicting packages are included into the new version of the document according to a process that maximizes the intent of the voting, and storing the document in multiple languages at the same time by automatically and/or manually translating edits that are made in given languages to all other supported languages.

In another aspect, the invention features a collaborative document creation system including a processor, a memory, a document repository containing documents, a database that holds the edits, votes, and keeps the time of durations within the document editing and voting processes, an interface configured to facilitate editing, voting, and visualization of contributor personal characteristics and positive or negative attitudes towards the document details and recording the identity of the contributors to a document, and a display unit for displaying the document and other information in the database.

The present invention may include one or more of the following advantages.

The method adapts a traditional petition style of community expression so that a final document expresses a set of collective beliefs and/or actions of the people supporting the document in the most empowering manner possible. The method allows this by enabling the document's creation, development of support, and pledge of support to occur simultaneously.

The method reduces the problems of section cooling, defined as a reduction of support because of a small subset of sections that a person disagrees with, and increases signer's investment, defined as how much a person is truly invested in a document when she signs the document, by enabling all final supporters of the document to play an integral role in the drafting and critiquing of the document.

The method gives all people, including those with ideas in the minority, a tool to influence the document creation, i.e., an ability to show that they will not support the document in its current form, and to clearly expresses and pinpoint their problem with the document. These pinpointed dissatisfactions of non-majority groups are continually shown, enabling changes to be offered and voted on that appease dissatisfactions from version to version of the document. This way, the method enables all people, even those not able to support the document at a particular version, to continually contribute to it in a positive, open, and real way.

By using this expression of dissatisfaction, along with sharing the burden of viewing and voting on edits across the entire group of contributors, the method can scale to an unlimited number of people.

The method links demographic properties to the contributor's positive and negative views of the document, have that be visualized for all users to see, and allows that to guide a direct democratic voting procedure of how the document changes from version to version.

### BRIEF DESCRIPTION OF THE DRAWINGS

The invention will be more fully understood by reference to the detailed description, in conjunction with the following figures, wherein:

FIG. 1 is a block diagram.

FIG. 2 is a block diagram.

FIG. 3 is an exemplary user interface (UI).

FIG. 4 is an exemplary UI.

FIG. 5 is an exemplary UI.

FIG. 6 is an exemplary UI.

FIG. 7 is an exemplary UI.

FIG. 8 is an exemplary UI.

FIG. 9 is an exemplary UI.

FIG. 10 is an exemplary UI.

FIG. 11 is an exemplary UI.

FIG. 12 is flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “contributor” refers to a specific document, and is a user that is either supporting or not supporting a given document. This is compared to a user, who is neither supporting or not supporting the document. All contributors are users, but the contributors to a document are a subset of the users viewing the document. A user decides to become a contributor when she supports the document by performing an action on the document. Some actions will make the user a supporter, such as making an edit, voting on something, or just stating that she wants to support it, and some actions will make the user a non-supporter, such as expressing a deal break on one or more sentences.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As shown in FIG. 1, a network 10 includes one or more user systems 12 and a server 14 linked to a network of interconnected computers (e.g., the Internet) 16. Links to the Internet 16 can be wired or wireless. Example user systems 12 include personal computers, laptop computers, netbook computers, tablets, smart phones, and so forth. Each of the user systems 12 includes a processor and memory. Memory includes an operating system, such as Linux®, Windows® or Android™, a browser process, and a word processing process, such as OpenOffice® Writer or Microsoft® Word, or a custom word processing process.

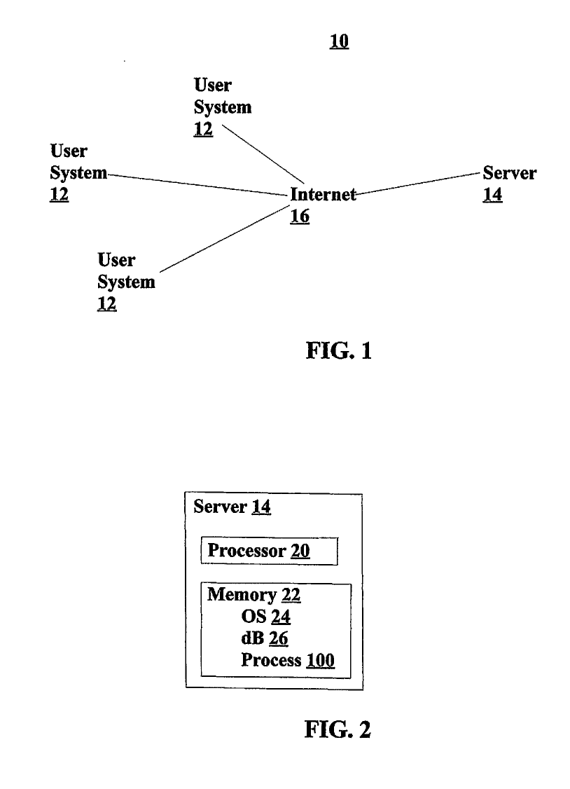

As shown in FIG. 2, the server 14 includes a processor 20 and memory 22. Memory 22 includes an operating system (OS) 24, such as Linux®, Windows®, and a process 100 for large scale document generation. The server 14 also includes a database 26, which can reside in memory or on a remote storage device.

Process 100 is an iterative process that enables multiple contributors on respective contributor's systems 12 to create a document, edit a document, and vote on the document edits that are made by other contributors, and to have these edits and votes be the basis for a compilation of a new version of the document of the original document. More specifically, when a new document is started, process 100 labels it version 1. After each editing/voting stage, the document version number increases sequentially, i.e., version 2, version 3, version 4, and so forth. The editing phase and voting phase can happen serially or concurrently.

Process 100 enables a user to contribute to a document, create a document or join a document that has already been started. Process 100 enables the user to invite others to edit the document with the user and to invite others to make votes on edits to the document. If desired, process 100 enables the user to enter and update personal demographic info.

By way of example, tags, such as age, gender, hobbies, occupation, and so forth, are used, along with a world location as each user's demographic information. Registration with this limited information enables natural groups to form within a community of any given document and an ability to recognize what non-majority ideas are being disenfranchised.

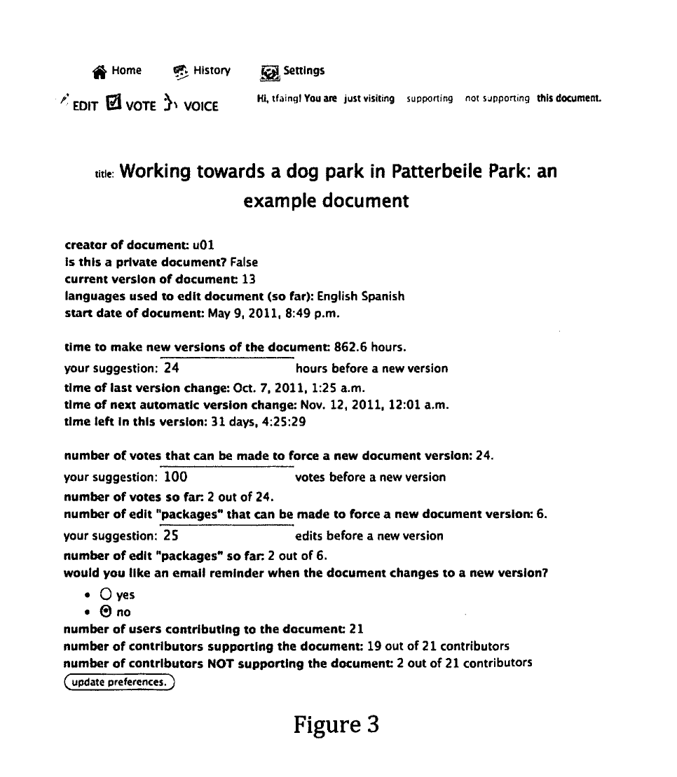

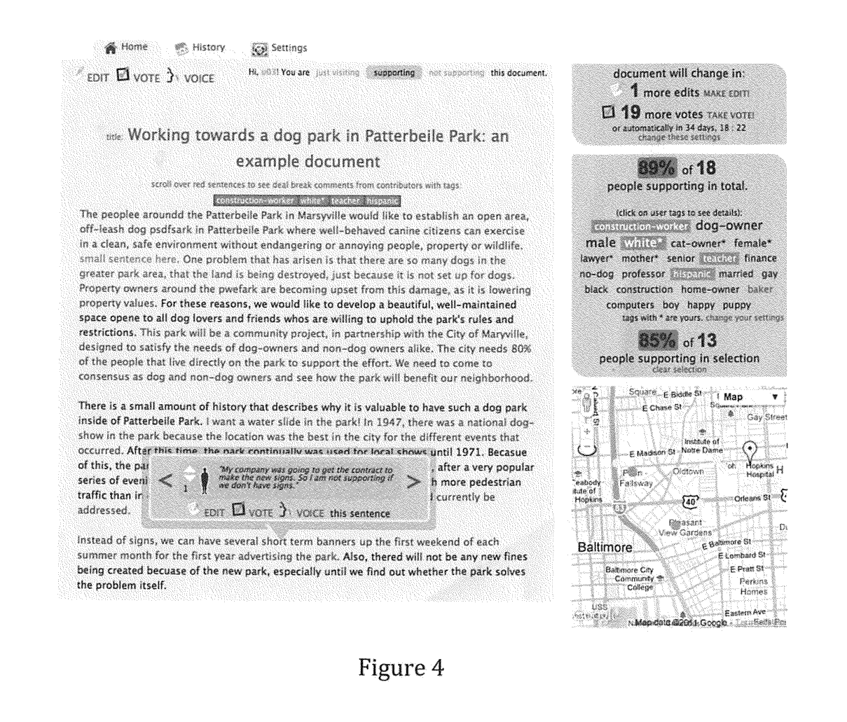

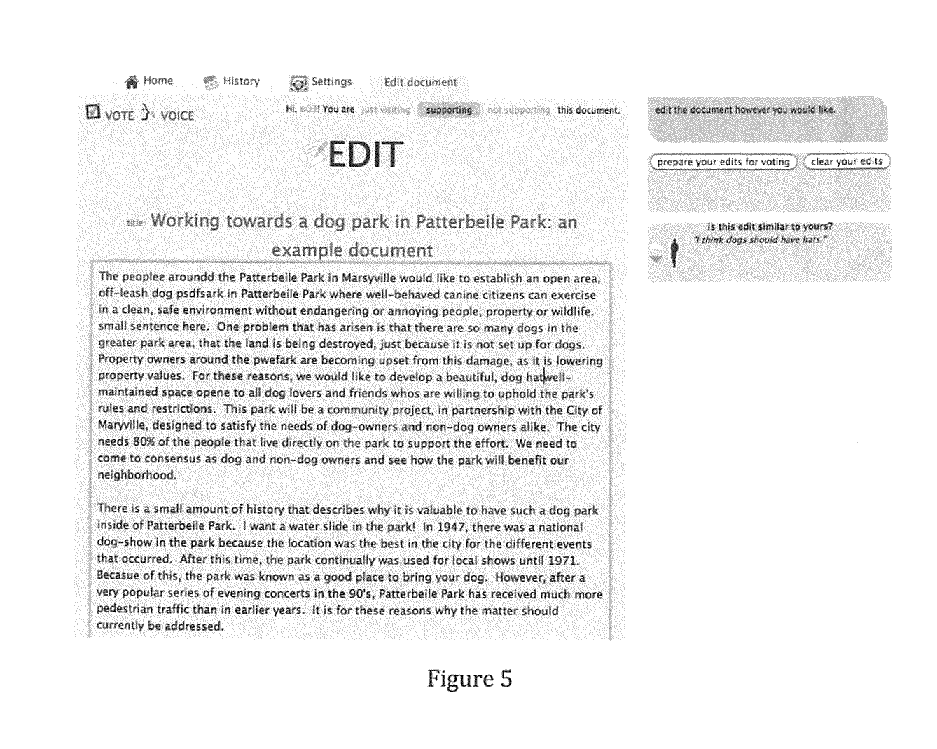

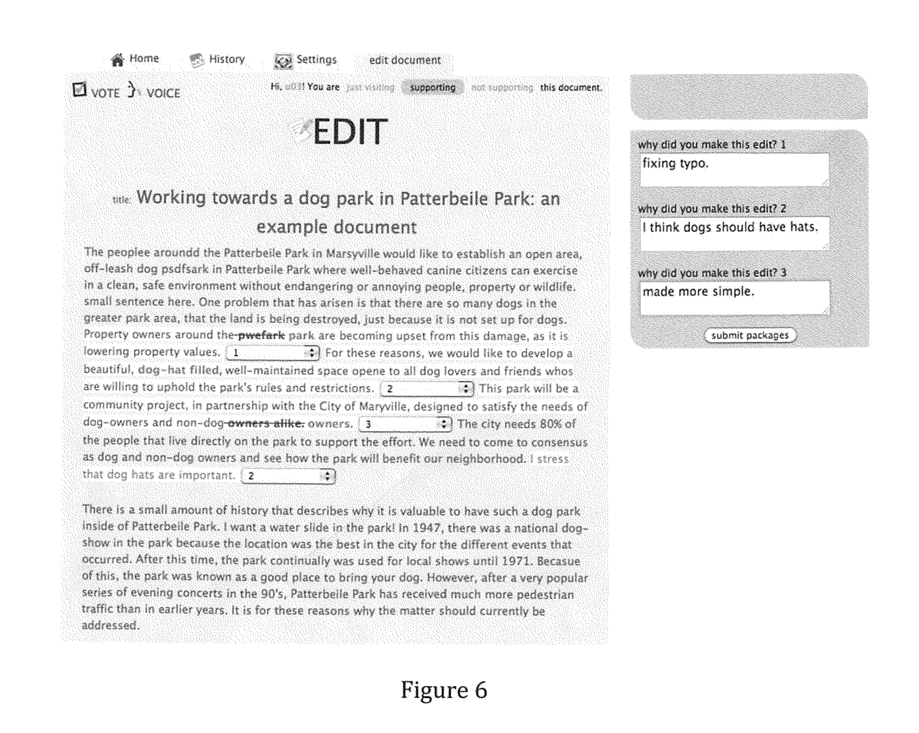

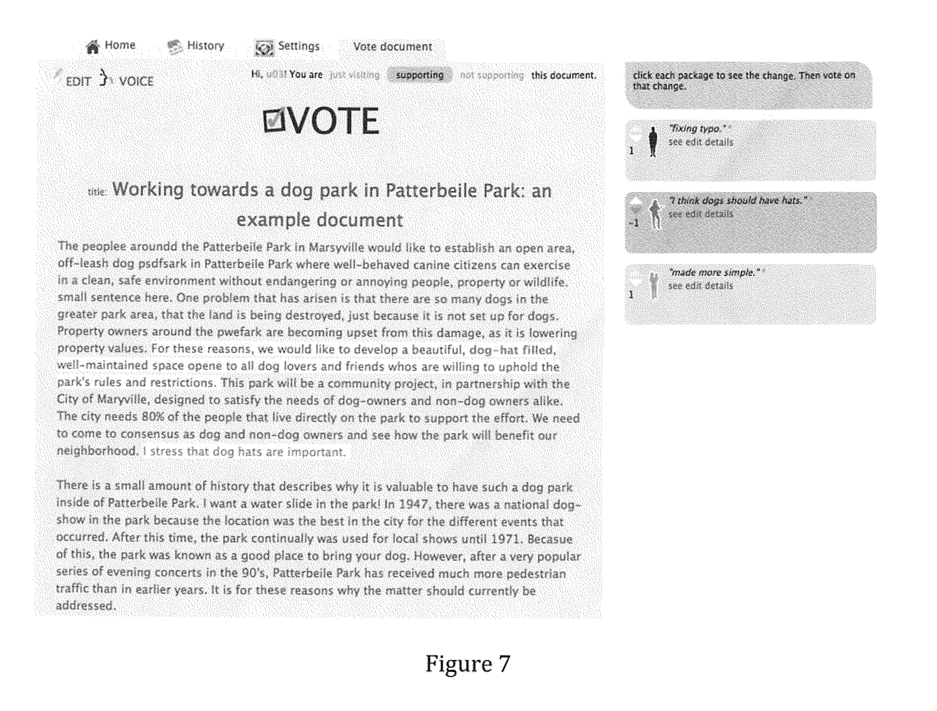

Process 100 includes an ability to view document/user support statistics, vote on document preferences, and voice dissent. Each user is permitted to vote on the ways that the document automatically moves from one version to the next. FIG. 3 is an exemplary user interface showing the document preferences that the user can vote on. An aggregation of these votes replaces the decision making that one lead author would have on a more traditional document. The words in the tag cloud are the sum of all the personal characteristics of the document's contributors. For a given document, process 100 enables users to view a current snapshot of who is supporting, and not supporting, the document. FIG. 4 is an exemplary UI showing a document statistics visualization. The larger the word in the tag cloud, the more people that are contributing to the document used that word to describe themselves. As the user selects combinations of tags in the tag cloud, the tags are highlighted, and the number of contributors that support and do not support the current version of the document with those tags is displayed, and their position shown on a map. A sub-set of contributors that are represented by a set of highlighted personal characteristics (such as tags) is called a selected group. With any selected group, the sentences in the document are highlighted to represent the level of dissatisfaction for those sentences within the selected group. These are the sentences that will make some contributors in the selected group not be able to support the document if they stay in as is. Also, for each highlighted sentence, a user can see some of the reasons why these highligthed sentences cannot be supported. During the editing phase of the document, contributors begin the overall editing process by editing the document in a normal way, in that the document is opened in an editor, and the user is free to make any changes and additions that he/she would like in edit. FIG. 5 is an exemplary UI showing editing. As the user types, process 100 periodically checks a database for edits that other contributors have made that are similar to the user's changes. When process 100 finds some, process 100 displays them to the contributor who is typing. The contributor can click on these edits and see whether they are similar enough for her to vote them up or not. After regular editing, the contributor is then given a list of the changes that she made, and is prompted to “pack” the changes. FIG. 6 is an exemplary UI showing more editing. A package is one or more sentences that a change was made in (including adding, deleting, and moving a sentence) that all go into the next version of the document, or all stay out, for the edit to make sense. Sentences in a package do not need to be abutting one another, and sentence packages can be intertwined, in that a sentence from one sentence package can be located in-between two sentences from another sentence package. Each package made will either go into the next version in its entirety, or not go in at all, based on the support the package receives in the succeeding voting phase. A comment for each sentence package can also be added. The comments that can be attached to each sentence package are a way to have experts in a given field explain and teach their rational for the edits that they make. The contributor votes packages up or down depending on whether he or she would like to see that edit in the document. FIG. 7 is an exemplary UI of voting. Scalability to an unlimited number of contributors is attainable by not having each contributor vote on every edit, rather by using a ranking algorithm that gives each contributor a combination of randomly selected packages as well as packages that are becoming popular or contentious based on voting patterns. The contributor is also able to show that she will not support the document in its current form, and to clearly expresses and pinpoint the issue that the contributor has within the document (referred to as VOICE). It is the combination of the ability to EDIT, VOTE, and VOICE, as well as specifically see dissatisfactions from non-majority groups, may allow the document to come to consensus in order to keep the size and diversity of the supporters of the document as high as possible. The contributor is allowed to vote on the preferred settings of the document, such as what criteria make the document go to a new version (explained in the next section), and how new versions are compiled (as shown in FIG. 3).

The end of the voting phase, process 100 compiles the document into a new version. This compilation is triggered by a predefined set of decisions of when the document should compile to a new version, which can be defined by the contributors (as shown in FIG. 3). Examples of the decisions that can lead to a compilation of a new version are a time limit for each version, the number of edits made in the version, the number of votes made on edits in a given document version, or some combination of these properties. Process 100 selects the packages that will be put into the next version of the document. Two packages are in conflict with one another when any sentence from one package overlaps or abuts (i.e., there is no “buffer” sentence between the two sentences) with a sentence from another package. Packages that are in conflict cannot both be put into the new version. Process 100 selects the package set—defined as a set of packages that can enter the document with no conflicts—that gives the most agreement to the community that is writing the document. A score can be defined for any package or package set in numerous ways by using the voting information for each package. One example of a package score is the amount of “YES” votes it receives, and the package set score is that sum total of the individual scores of the packages in the set.

Process 100 can search for the package set with the highest score can be performed in several ways. One embodiment is as follows: (a) remove all sentences that have more “NO” votes than “YES,” (b) the remaining packages are ordered into a list by their package score as described above, for each package in the list, remove the packages that are lower in the ordered list if they conflict with the current package. The packages in the list remaining after this removal is the package set. It is possible that this will not find the optimal package set. For example, the highest voted package, if not put into the document, could allow for many other packages to enter in, which would make for a higher overall package set score. A complication to search for such scenarios is to replace the singe list selection with all N! possible orderings for the packages. Then the list with the largest package set score is selected. If the calculation becomes too large (with N! needing to take place), a Monte Carlo algorithm can be implemented to search for the highest scoring list and package set. In either case, showing a graph of the package set scores of all possible package sets for a given edit, ranked from highest to lowest package set score, one would see a curve that dies off as the package set become less and less valuable. Only in the comparison of the N! package sets would one be guaranteed to select the highest scored package set. The drop off of the ranked package set scores can determine the level of overall acceptance of the version compile: a greater drop-off means that the highest score package set is the clearest choice out of all of the other potential package sets to maximize the satisfaction in the next version.

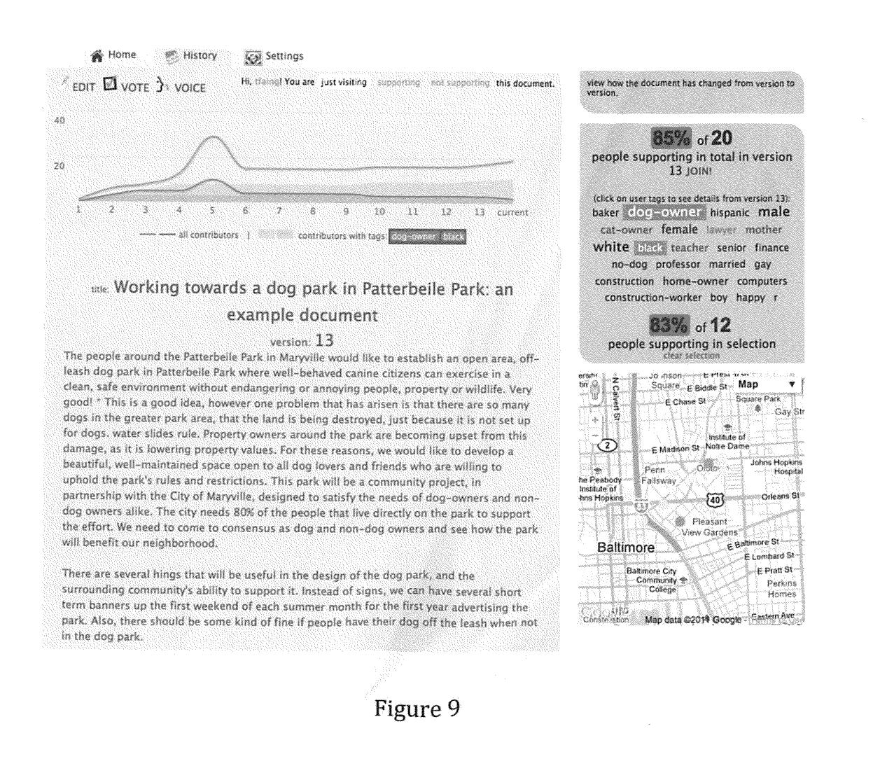

Within the history page of the visualization, results of each compilation are shown to the user as well as the history of the support statistics for all contributors and selected groups. FIG. 9 is an exemplary UI showing documents statistics history. For each package that was voted on, it can be viewed what demographic of contributors voted for or against it. If it is desired by a contributor to retake the vote for the package in the new version, the contributor can re-edit the new version so that it meshes with the older version edit, and so that will be voted on when the new version compiles.

After any given voting phase, when a new version of the document is compiled, there is a strong possibility that groups of contributors with ideas that are not in the majority (i.e., any idea that has the support of more than 50% and less than or equal to 100% of the contributors) have been disenfranchised, and handling this will be a very important step in the creation of the document. The difficulty of reaching consensus between differently sized groups can be shown in an example.

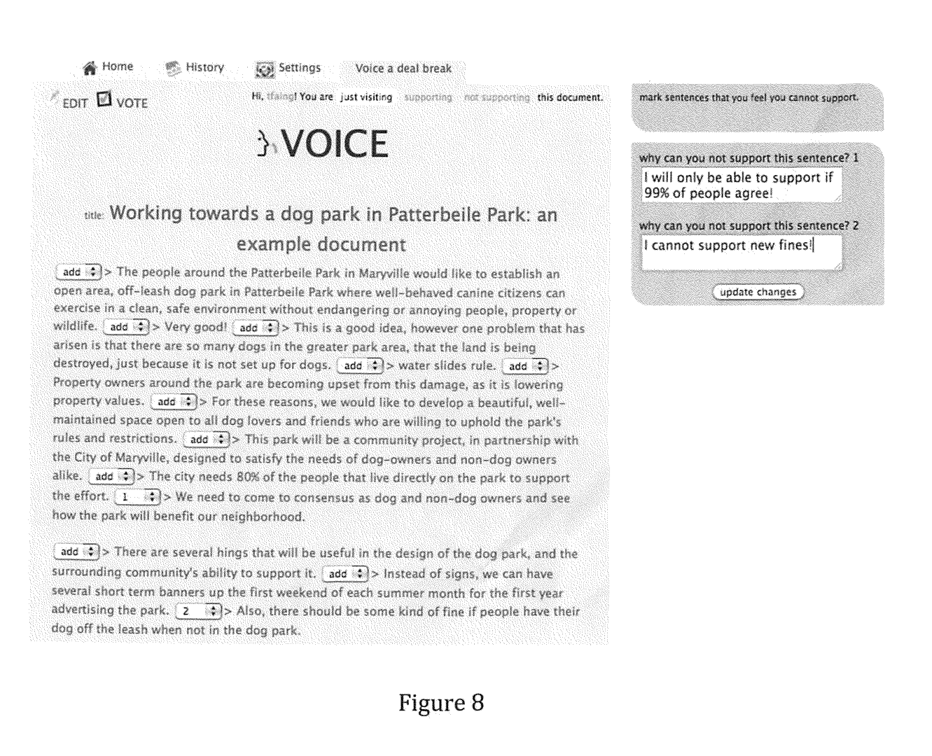

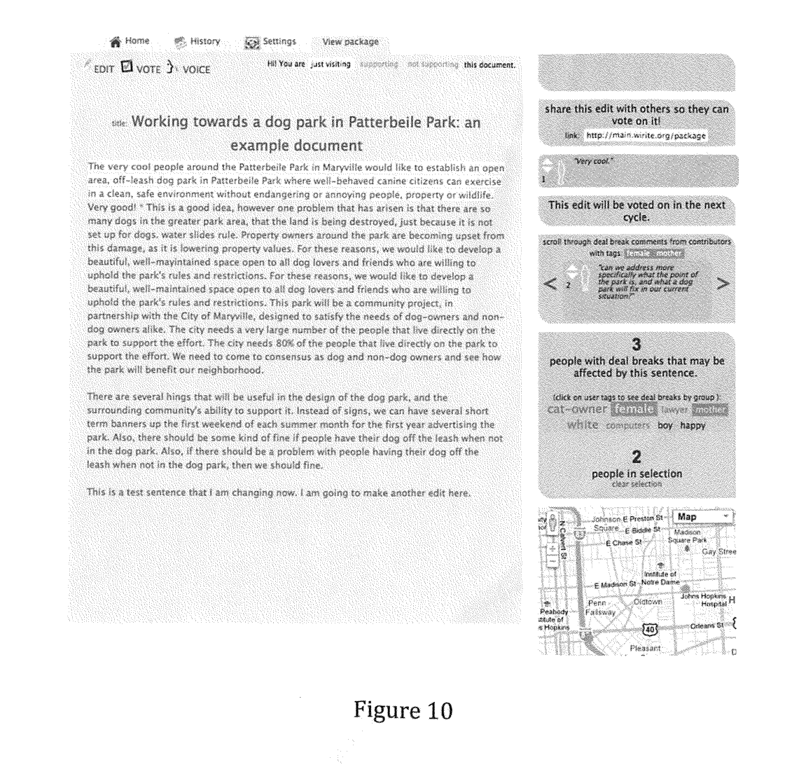

There are 100 contributors of persuasion A and 1000 contributors of persuasion B of a given topic. There is some change in the document that is voted on. There are 10 votes not to change from group A, and 900 votes to change from group B. This is a clear signal to make the change. But what if there is 70 votes from group A not to change and 400 votes to change from group B. Clearly, the majority vote says to make the change, but 70% of the non-majority group didn't want it. This type of problem will arise naturally and often. One way to solve this—by normalizing the votes to group's size, is difficult and undesirable because the idea of a definable group A or B or any other group, although useful, either doesn't exist in the real world or it is very difficult to define without typecasting or profiling contributors. Also, any set of defined groups have overlapped enrollments, which makes normalization impossible. It would therefore be unrealistic to use such groupings to reduce conflict. Process 100 solves such problems by allowing contributors to mark particular sentences in the document as deal breaks: the contributors will not support the final document if the deal break sentence or sentences stay in the document. FIG. 8 is an exemplary UI of voicing dissent on the document. In any version of the document, it can be seen how many contributors are supporting the document (could sign the document as is) or not supporting the document (have one or more deal breaks that disallow them from signing the document as is). This information can fluidly change from version to version as new contributors enter the document, edits are made, votes are taken, new versions are created, and new deal breaks are expressed. Using the information about deal breaks and loss of certain non-majority groups from the support of the document, one option for editors on any given editing stage (in addition to adding brand new content or making stylistic changes) is to come to consensus with a given deal break sentiment. During voting, contributors can see how a given package they are voting on may increase the level of support by seeing the deal breaks for different minority groups on a particular sentence as they are voting on a change to that sentence. FIG. 10 is an exemplary UI showing this ability during the voting on a package.

The premise of the deal break system described above is that if dissatisfactions from non-majority groups are seen clearly by the larger group, and the loss of support is realized due to the dissatisfaction of non-majority groups, then there will be an effort to come to consensus to keep the size and diversity of the supporters of the document as high as possible. This is because a decision or cause that has support from contributors with non-majority ideas is a very powerful force for change, especially if it is an issue that requires support from a diverse group of contributors. The goals are a maximization of contributors that support the document with the most diversity possible and to avoid gridlock when the system veers into a standoff position.

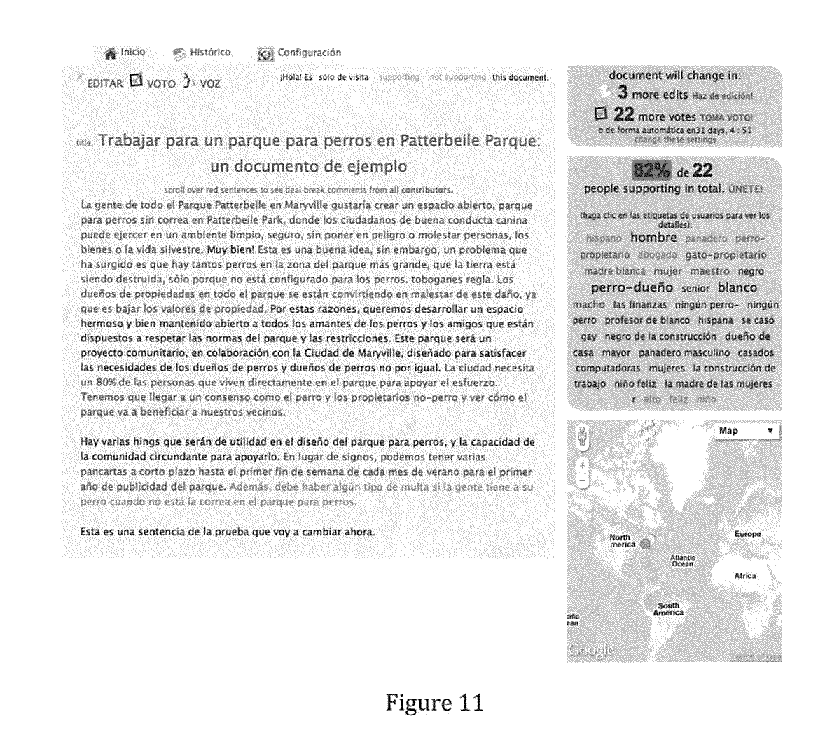

A particular instance of the schema to store the information about the documents, their version histories, about contributors' edits on them, the creation of packages, expressions of deal breaks, votes on specific packages, and commenting which allows for the functionality mentioned above is to treat the sentence as the fundamental unit of the method. In the beginning of each new version of the document, each sentence is assigned a location, e.g., a set of 3 numbers similar to the Dewey decimal system that explicitly defined what the Chapter, Paragraph, and Sentence location is for that sentence (any set of subdivisions can be used, but here we give the example of Chapter and Paragraph divisions in addition to the Sentence). For example, the first three sentences in Chapter 2, paragraph 3 would be C:2/P:3/S:1, C:2/P:3/S:2, C:2/P:3/S:3. When a document is edited, sentences can either be deleted, moved, changed or inserted. These actions are logged for the affected sentences as CHANGED FROM, CHANGED TO, DELETED, INSERTED, MOVED FROM, MOVED TO. For the sentences that are CHANGED TO, MOVED TO, and INSERTED, a location is given that is fractional to the original location structure, defining where the sentence exists with respect to the original document sentences. During the edit, new sentences are created, along with the fractional location information of where they exist with respect to the original version. If a sentence is CHANGED TO or MOVED TO or both, this adapted sentence has a pointer to the sentences that were CHANGED FROM and MOVED FROM respectively. And reversely, the CHANGED FROM and MOVED FROM sentenced point to their CHANGED TO or MOVED TO counterparts. Process 100 therefore allows for complete tracking of the creation, evolution, movement, and deletion, of every sentence as it is manipulated from version to version. The definition of conflicting packages falls out from the sentence locations of the proposed changes. For example, if any two packages have a sentence with a location code where the Chapter and Paragraph numbers are equal, and the Sentence number is equal or less than an integer value away from the other, then the two packages are in conflict. This keeps the criteria of having at least one sentence from the old version between sentences from packages that are accepted into a new version. When new versions of the document are compiled, the sentences from packages in the selected package set that are INSERTED, CHANGED TO, and MOVED TO are all turned on in the new version, and the sentences that are DELETED, CHANGED FROM, and MOVED FROM are all turned off in the next version. The location numbers for each sentence are then refreshed by reassigning integer locations to the sentences in the new version. Although process 100 can be used in any single language, another aspect of the method is its ability to allow contributors that speak and write in different languages to edit the same document with one another. FIG. 11 is an exemplary UI showing multi-language editing. Because the sentence is the fundamental unit of editing, discussion, and voting, each sentence can be immediately and automatically translated to other languages when it is created. Comments on packages and votes as well as the contributor tags are also immediately and automatically translated. Each sentence is in reality a multitude of sentences, one being the original, and the other being automatic translations of the original into all of the languages that the method supports. By doing this, the actions allowing collaboration, editing, voting, and discussion within the same document can be performed using any language. This makes the entire process of collaboration on a document language-independent.

In another example of using an automatic translation algorithm, process 100 can request that the automatic translation algorithm balance the translation quality with a tendency to minimize word movement during the translation, thereby making the comparisons between changes in sentences of different languages more uniform.

In another example that does not use automatic translation, multilingual contributors can perform the task of manually translating sentences, and the most liked translations can be selected by a voting procedure similar to that of the edits contributors make.

The contributor can choose what level of detail he/she wants to see concerning the language of each sentence and comment, from not having any language information visible, to seeing a mark such as a asterisk or the language name highlight sentences and comments not originally created in the language she is viewing the document in, to showing every sentence in its original language. As edits and voting take place, process 100 shows the steps in only the language that is being displayed at the time. Asterisks next to sentences and comments are used for all text that has been automatically or manually translated. After compilation, when new sentences enter the document that were created in different languages, one can see that the new version has sentences that were voted in that were originally created in different languages.

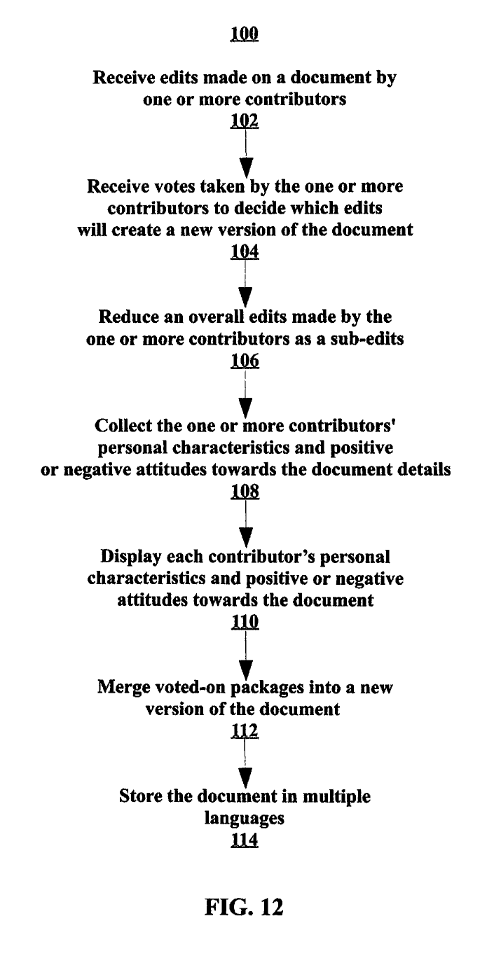

As shown in FIG. 12, process 100 includes receiving (102) edits made on a document by one or more contributors.

Process 100 receives (104) votes taken by the one or more contributors to decide which edits will create a new version of the document.

Process 100 reduces (106) an overall edits made by the one or more contributors as packages.

Process 100 collects (108) the one or more contributors' personal characteristics and positive or negative attitudes towards the document details and displays (110) each contributor's personal characteristics and positive or negative attitudes towards the document details so that it is known by all of the contributors how voted-in edits will change a support level of all contributors.

Process 100 merges (112) voted-on packages into a new version of the document so that non-conflicting packages are included into the new version of the document according to a process that maximizes the intent of the voting.

Process 100 stores (114) the document in multiple languages at the same time by automatically and/or manually translating edits that are made in given languages to all the other supported languages.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. For example, various forms of the flows shown above may be used, with steps re-ordered, added, or removed. Accordingly, other implementations are within the scope of the following claims.

What is claimed is:

1. A method comprising:
in a server linked to a plurality of user systems, receiving edits made on a document by one or more contributors;
receiving votes taken by the one or more contributors to decide which edits will create a new version of the document; and
reducing an overall edits made by the one or more contributors as packages, the package representing a smallest unit of an edit that can enter the document independent of one another, which are independently voted on, allowing voting by all contributors on whether each package should go into a next version of the document.

2. The method of claim 1 further comprising:
collecting the one or more contributors' personal characteristics and positive or negative attitudes towards the document details; and
displaying each contributor's personal characteristics and positive or negative attitudes towards the document details so that it is known by all of the contributors how voted-in edits will change a support level of all contributors.

3. The method of claim 2 further comprising:
at the end of each editing and voting stage, merging voted-on packages into a new version of the document so that non-conflicting packages are included into the new version of the document according to a process that maximizes the intent of the voting.

4. The method of claim 3 further comprising:
storing the document in multiple languages at the same time by a combination of manual and automatic translations of edits and enabling all document interactions to occur in multiple languages.

5. The method of claim 1 wherein an aggregate voting of contributors concerning procedures for the development of the document replace the decision making of a single head contributor or contributors.

6. The method of claim 1 wherein negative attitudes of a given contributor is a deal breaker such that the contributor will not support the document if the part of the document that the contributor marks as a deal breaker stays in the document without change.

7. The method of claim 1 wherein a contributor's positive or negative attitudes towards the document details are expressed on a sentence by sentence basis, and words or phrases are attributed to each contributor are used as the contributor's personal characteristics to be expressed with the contributor's positive or negative attitudes towards the document details.

8. The method of claim 1 wherein the document compiles to a new version after a given number of edits have been made, votes have been taken on the edits made, and/or a set amount of time has expired for the stage.

9. The method of claim 1 wherein an editing stage occurs before a voting stage of a given version stage or that the edit and voting stage happen at the same time during a given version stage.

10. A collaborative document creation system comprising:
a processor;
a memory;
a document repository containing documents;
a database that holds the edits, votes, and keeps the elapsed time of the stage; and
an interface configured to facilitate editing, voting, and visualization of contributor personal characteristics and positive or negative attitudes towards the document details, and recording the identity of the contributors to a document.

11. The system of claim 10 further comprising a display unit for displaying the document and other information in the database.

12. The system of claim 11 wherein the user can select a sub-set of personal characteristics from a list of personal characteristics which defines a selected group that share the selected sub-set of personal characteristics.

13. The system of claim 12 wherein a selected groups' support level for portions of the document can be viewed by a user.

14. The system of claim 12 wherein expressed dissents of selected groups can be viewed for portions of the document.

15. The system of claim 12 wherein a user is shown packages that can remove dissents of selected groups.

16. The system of claim 12 wherein a contributor can create a package to specifically address the dissents of selected groups.

17. The system of claim 12 wherein a contributor can view the history of support levels of selected groups for all past versions of the document.

18. The system of claim 17 wherein the user can view why a given package did or did not make it into the new version by viewing the voting statistics linked to selected groups.

19. The system of claim 18 wherein the contributor can revive an older version package that did not make it into a previous document version by re-editing the package so that it can be voted on again in the current version of the document.

20. The system of claim 12 wherein while a given contributor is drafting an edit, other edits that have been inputed by other contributors that are similar to the given contributor's edits are displayed so that they may be voted on by the contributor making the edit.
